(19) United States
(12) Patent Application Publication
(10) Pub. No.: US 2017/0046955 A1
(43) Pub. Date: Feb. 16, 2017

(54) Method and System of Locating and Managing Parking Space

(71) Applicant: Zhixuan Shen, El Monte, CA (US)

(72) Inventor: Zhixuan Shen, El Monte, CA (US)

(21) Appl. No.: 14/824,050

(22) Filed: Aug. 11, 2015

(51) Int. Cl. G08G 1/14

(52) U.S. Cl. CPC G08G 1/14

(57) ABSTRACT

A method of locating and managing parking space, comprising the steps of: collecting parking data regarding any available parking space within a geographic parking location by a central computerized unit in a real time manner; receiving a parking request from the driver, containing a geographic location of a vehicle of the driver, to the central computerized unit; sending out the parking data to the driver to be displayed on a map of the driver within the geographic parking location to show any available parking space within the geographic parking location; receiving a reserve request from the driver when any one of parking spaces is available; and indicating the available parking space selected by the driver as a reserved space.

### NOTICE OF COPYRIGHT

A portion of the disclosure of this patent document contains material which is subject to copyright protection. The copyright owner has no objection to any reproduction by anyone of the patent disclosure, as it appears in the United States Patent and Trademark Office patent files or records, but otherwise reserves all copyright rights whatsoever.

### BACKGROUND OF THE PRESENT INVENTION

Field of Invention

The present invention relates to a parking space management system, and more particular to a method and system of locating and managing parking space, wherein the driver is able to find any available parking space and to reserve it in advance, so as to reduce street congestion and frustration of the driver.

Description of Related Arts

Drivers always get frustrated when finding a parking spot in many cities. Due to the limited supply of parking spots, finding a parking spot requires time, luck, and/or the risk of an expensive parking ticket, especially for those street parking spots. Parking lots and parking structures are alternative ways for the drivers to find an open spot easily. Especially the parking structures provide multi-storey of covered and uncovered parking spaces, the drivers may easily find the open space in the parking structure. However, the cost of such parking structure is significantly higher than that of the street parking spot.

In addition, most drivers have the same experience that there is always a traffic congestion in the parking structure because the drivers need to stop and get a ticket at the entrance of the parking structure and need to slowly search any available parking space from the lowest level of the parking structure to the highest level thereof. As a result, the drivers will pay for additional parking fee when searching the available parking space and during traffic congestion in the parking structure, and the drivers will fight for any parking space under the frustrated situation. It would be advantageous to provide a parking management to direct the driver to the parking space which makes the parking structure less congested and safer.

An advanced parking management comprises a parking sensor to detect any open spot in the parking structure and a display at the entrance of each level of the parking structure to indicate the number of open spots in each level of the parking structure. However, the parking management does not accurately provide the open spot due to the in-and-out of the vehicles and cannot provide a particular empty space in each level. In other words, the drivers will keep circling the same level for searching the open spot even though the display at that level indicates only one empty space. Therefore, the drivers have no choice to take any available parking space even though the space is compact.

### SUMMARY OF THE PRESENT INVENTION

The invention is advantageous in that it provides a method and system of locating and managing parking space, wherein the driver is able to find any available parking space and to reserve it in advance, so as to reduce street congestion and frustration of the driver.

Another advantage of the invention is to a method and system of locating and managing parking space, wherein the driver is able to select and reserve any available parking space, such that the driver is directed to the selected parking space which makes the parking structure less congested and safer.

Another advantage of the invention is to a method and system of locating and managing parking space, which will directly guide to the driver via the guidance direction to the reserved space on the map of the driver.

Another advantage of the invention is to a method and system of locating and managing parking space, which allows the driver to sell the reserved space to other driver so as to substantially reduce the parking fee paid by the driver. In addition, all the parking spaces can be effectively occupied.

Another advantage of the invention is to a method and system of locating and managing parking space, which can incorporate with any existing parking sensor to collect parking data of the parking structure.

Another advantage of the invention is to a method and system of locating and managing parking space, which does not require to alter the original structural design of the parking structure, so as to minimize the manufacturing cost of the parking structure incorporating with the system of the present invention.

Another advantage of the invention is to a method and system of locating and managing parking space, wherein no expensive or complicated structure is required to employ in the present invention in order to achieve the above mentioned objects. Therefore, the present invention successfully provides an economic and efficient solution for helping the drivers to look for available parking spaces and for guaranteeing the reserved space selected by the driver.

Additional advantages and features of the invention will become apparent from the description which follows, and may be realized by means of the instrumentalities and combinations particular point out in the appended claims

According to the present invention, the foregoing and other objects and advantages are attained by a method of locating and managing parking space, comprising the following steps which are executed by a computer.

(1) Collect parking data regarding any available parking space within a geographic parking location by a central computerized unit in a real time manner, wherein a driver is able to wirelessly communicate with the central computerized unit through a wireless communication network.

(2) Receive a parking request from the driver, containing a geographic location of a vehicle of the driver, to the central computerized unit through the wireless communication network.

(3) Send out the parking data to the driver to be displayed on a map of the driver within the geographic parking location through the wireless communication network to show any available parking space within the geographic parking location.

(4) Receive a reserve request from the driver through the wireless communication network when any one of parking spaces is available.

(5) Indicate the available parking space selected by the driver as a reserved space.

In accordance with another aspect of the invention, the present invention comprises a system of locating and managing parking space, comprising a management communicator, a central management module, and a confirmation center, wherein a computer executes the above mentioned modules.

The management communicator is adapted for being installed into and executed by a mobile electronic device of a driver.

The central management module comprises a database and a communication module. The database, which collects parking data regarding any available parking space within a geographic parking location in a real time manner, is adapted for being accessed by the mobile electronic device of the driver through a wireless communication network. The communication module is operatively linked to the database, wherein the communication module receives a parking request from the management communicator, containing a geographic location of a vehicle of the driver, through the wireless communication network and sends out the parking data to the management communicator for being displayed on a map of the driver within the geographic parking location through the wireless communication network to show any available parking space within the geographic parking location.

The confirmation center is operatively linked to the communication module for receiving a reserve request from the management communicator through the wireless communication network when any one of parking spaces is available and for indicating the available parking space selected by the driver as a reserved space.

Still further objects and advantages will become apparent from a consideration of the ensuing description and drawings.

These and other objectives, features, and advantages of the present invention will become apparent from the following detailed description, the accompanying drawings, and the appended claims.

### BRIEF DESCRIPTION OF THE DRAWINGS

FIG. 1 is a flow diagram illustrating a method of locating and managing parking space according to a preferred embodiment of the present invention,

FIG. 2 is a block diagram illustrating a system of locating and managing parking space according to the above preferred embodiment of the present invention.

FIG. 3 illustrates an interface of the system according the above preferred embodiment of the present invention.

### DETAILED DESCRIPTION OF THE PREFERRED EMBODIMENT

The following description is disclosed to enable any person skilled in the art to make and use the present invention. Preferred embodiments are provided in the following description only as examples and modifications will be apparent to those skilled in the art. The general principles defined in the following description would be applied to other embodiments, alternatives, modifications, equivalents, and applications without departing from the spirit and scope of the present invention.

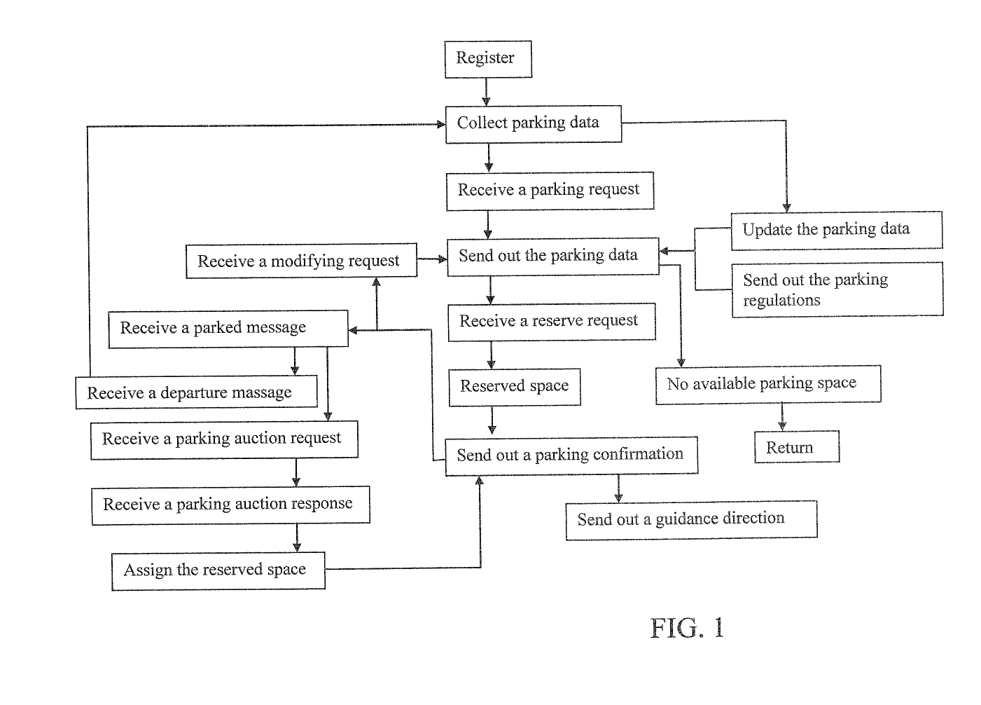

Referring to FIG. 1 of the drawings, a method of locating and managing parking space according to a preferred embodiment of the present invention is illustrated, wherein the method comprises the following steps.

(1) Collect parking data regarding any available parking space within a geographic parking location by a central computerized unit in a real time manner, wherein a driver is able to wirelessly communicate with the central computerized unit through a wireless communication network.

(2) Receive a parking request from the driver, containing a geographic location of a vehicle of the driver, to the central computerized unit through the wireless communication network.

(3) Send out the parking data to the driver to be displayed on a map of the driver within the geographic parking location through the wireless communication network to show any available parking space within the geographic parking location.

(4) Receive a reserve request from the driver through the wireless communication network when any one of parking spaces is available.

(5) Indicate the available parking space selected by the driver as a reserved space.

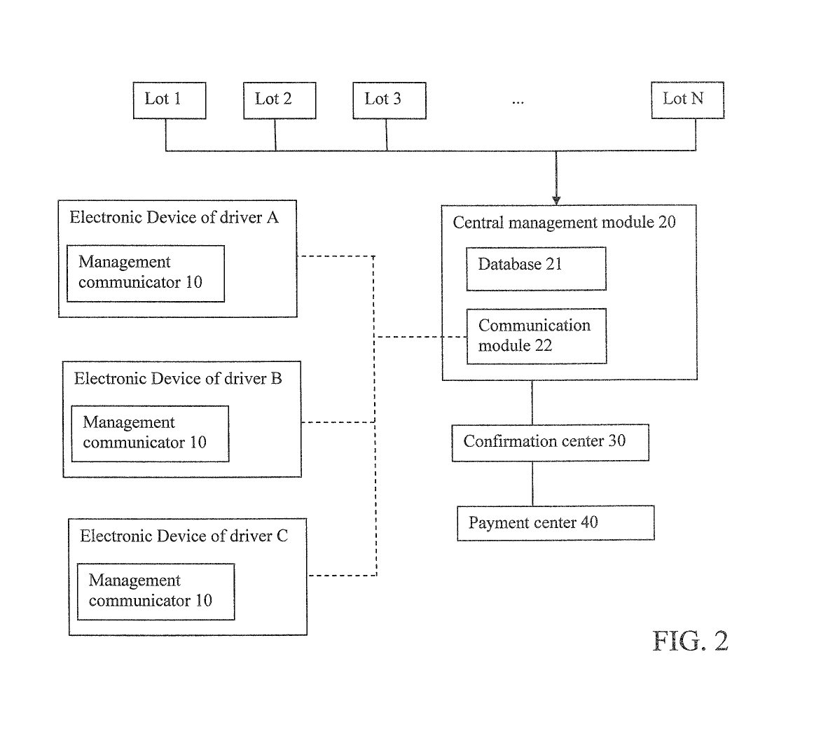

According to the preferred embodiment, the system of locating and managing parking space serves as the central computerized unit, wherein the system comprises a management communicator 10, a central management module 20, and a confirmation center 30, as shown in FIG. 2. Accordingly, a parking structure is illustrated as an example in the present invention to assist a driver to quickly find an open spot (available parking space) in the parking structure having multi-storey and a plurality of parking spaces at each level thereof.

The management communicator 10, which is embodied as software or an application, is adapted for being installed into and executed by an electronic device of the driver. Preferably, the driver is able to download and install the management communicator 10 into a mobile electronic device, such as mobile phone.

Preferably, the method of the present invention further comprises registering step of requesting the driver to register the central computerized unit of the system as a registered user, such that when the registered user submits the reserve request to the central computerized unit, the reserved space is confirmed by personal information of the registered user. Accordingly, the driver is able to input personal information to a user database of the central management module 20, such that the registered user is able to log in the central management module 20 via the management communicator 10 by inputting a username and password provided by the system of the present invention.

The central management module 20 comprises a database 21 and a communication module 22. Accordingly, in the step (1), the database 21 collects the parking data regarding any available parking space within the geographic parking location in a real time manner. It is worth mentioning that the available parking space can be detected by any existing parking sensor in the parking structure, such that the parking sensor is able to send the parking data to the central management module 20 and to be collected by the database 21. The parking data contains the occupied parking spaces and unoccupied parking spaces at each level of the parking structure. It is worth mentioning that the parking data can include all the parking spaces in different parking structure.

In addition, the database 21 is adapted for being accessed by the mobile electronic device of the driver via the management communicator 10 through the wireless communication network, such as a mobile communication network or Internet. In other words, the driver is able to use the mobile phone to access the database 21 via the management communicator 10 installed into the mobile phone.

The communication module 22 is operatively linked to the database 21, wherein the communication module 22 receives the parking request from the management communicator 10 operated by the driver, as shown in the step (2). Accordingly, the parking request contains the geographic location of the vehicle of the driver through the wireless communication network. In particular, the management communicator 10 will contain the geographic location of the vehicle of the driver through the location service of the electronic device. Therefore, the management communicator 10 will send the geographic location of the vehicle to the communication module 22 when the parking request is sent from the electronic device of the driver. The driver is able to select which geographic parking location of the parking structure by the parking request. For example, the driver is able to input the destination, such as address, zip code, city name, etc by voice or text through the electronic device to define the geographic parking location of the parking structure. In response to the input by the driver, the database 21 will sort out the parking structures around the destination within the geographic parking location thereof.

In the step (3), the communication module 22 will send out the parking data to the management communicator 10 through the wireless communication network, such that the parking data can be displayed on the map in the electronic device of the driver, via a mapping software thereof, within the geographic parking location to show any available parking space within the geographic parking location.

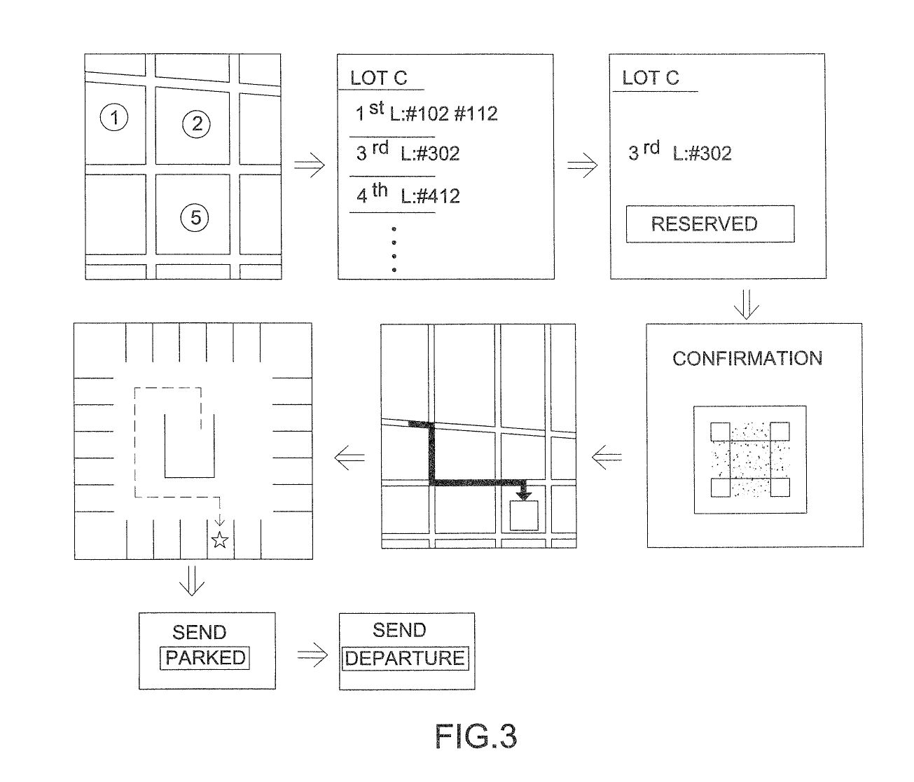

In particular, the driver is able to view different geographic parking locations of the parking structures when sending the parking data from the communication module 22, as shown in FIG. 3. The interface of the map will show different geographic parking locations of the parking structures and any available parking space in each parking structure.

It is worth mentioning that the driver is able to change the input anytime by submitting another parking request to the communication module 22, such that different geographic parking locations of the parking structures will be displayed on the map of the electronic device of the driver.

According to the preferred embodiment, the driver is able to select a desired geographic parking location of the parking structure before sending out the reserve request from the driver through the wireless communication network when any one of parking spaces is available as shown in the step (4).

When one of the parking structures is selected by the driver, the communication module 22 will send out the parking information to the driver through the wireless communication network. The parking information includes the parking fee of the parking structure, a particular location of the available parking space, and parking regulations of the parking structure. For example, when the driver selects “Lot 2” as the designated parking structure, the parking information of “$10/hr”, “#213 at second level, #322 at third level . . . ”, and “minimum 1 hour”. When the driver selects “Lot 4” as the designated parking structure, the parking information of “Free”, “#103 at first level”, and “maximum 2 hour”.

In addition, the parking data will be frequently updated from the database 21 to the driver via the management communicator 10 to update the available parking space within the geographic parking location. When any parking space becomes available, such as other driver leaves the parking space or other driver cancels the reserved space, the updated parking data will be automatically updated in the database 21 and sent from the communication module 22 to the driver.

The confirmation center 30 is operatively linked to the communication module 22 for receiving the reserve request from the management communicator 10 through the wireless communication network when any one of parking spaces is available and for indicating the available parking space selected by the driver as a reserved space, as shown in the step (5).

When the desired parking space at the geographic parking location of the parking structure is selected by the driver, the driver is able to send the reserve request via the management communicator 10 to the confirmation center 30. Then, the confirmation center 30 will automatically configure the statue of the selected parking space from “available” to “reserved”. Therefore, other drivers will not able to select the reserved space.

Preferably, the reserve request is sent by the driver when the vehicle of the driver is located within a predetermined distance range the available parking space. For example, the reserved request must be sent when the vehicle of the driver is located within 2 miles from the selected parking structure. Otherwise, the reserved space becomes open space when the reserved space is unoccupied by the driver after an expiring time limit For example, the reserved space will be canceled after 30 minutes at the same time the reserve request is submitted.

It is worth mentioning that the parking request sent by the driver further contains mobile phone number of the driver via the management communicator 10, such that the reserved space is verified by the mobile phone number of the driver in a paperless ticket manner. In other words, the parking request contains the information of the reserved space selected by the driver and the mobile phone number of the driver, such that in order to park the vehicle at the reserved space, the confirmation center 30 will verify the mobile phone number whether it matches with the parking request or not. Preferably, only one reserved space is selected at one time by the driver. Preferably, the parking request further contains a vehicle license plate number.

For registered user, the parking request sent by the driver further contains personal information of the driver via the management communicator 10, such that the reserved space is verified by the personal information of the driver in a paperless ticket manner. It is worth mentioning that the driver does not require getting any ticket at the entrance of the parking structure and does not have to rush for searching any open spot which makes the parking structure less congested and safer.

In the step (5), the method of the present invention further comprises the following steps.

(5.1) Send out a parking confiriiiation of the reserved space to the driver. Accordingly, the parking confirmation can be a confirmation code such as QR code, barcode, or text code sent to the driver. Therefore, once the parking confirmation is received by the driver, the reserved space will be saved for the driver.

(5.2) Frequently send out a guidance direction to the driver to guide the driver to the reserved space on the map of the driver from the current location thereof. Once the parking confirmation is sent to the driver, the driver has an option to receive the guidance direction from the communication module 22. As a result, a first guidance route is generated, in response to the guidance direction, from the geographic location of the vehicle of the driver to the selected parking structure, to guide the driver to drive to the selected parking structure. Once the driver enters into the selected parking structure, a second guidance route is generated to guide the driver to drive from the entrance of the parking structure to the reserved space.

For fee-required parking structure, applicable parking fee is charged after a predetermined time period at the time the reserved space is confirmed. For example, the applicable parking fee is automatically charged after 15 minutes at the time the reserved space is confirmed. Alternatively, the parking fee may start to count when the reserve request is submitted, such that the reserved space will not be canceled at any time.

Accordingly, the system further comprises a payment center 40 operatively linked to the confirmation center 30, wherein the registered user can open an personal account in the payment center 40, such that the registered user can deposit a predetermined amount of money in the personal account to pay the parking fee. Likewise, the registered user can put the credit card information in the payment center 40 to pay the parking fee.

According to the preferred embodiment, the driver is able to change or cancel the reserved space after the parking confirmation is received and before the vehicle of the driver is parked. Accordingly, the communication module 22 will receive a modifying request from the driver to request a location change of the reserved space. Then, the communication module 22 will send out the parking data again to the management communicator 10 through the wireless communication network, such that the parking data will be displayed on the map in the electronic device of the driver, via the mapping software thereof, within the geographic parking location to show other available parking space within the geographic parking location.

The driver is able to select any desired parking space in the same parking structure or in different parking structure as long as one of parking spaces is available. The communication module 22 will send out the parking information to the driver in response to the selected parking structure. Once the available parking space is selected, the confirmation center 30 will receive a second reserve request from the driver through the wireless communication network. Then, the confirmation center 30 will indicate the available parking space selected by the driver as a modified reserved space. Accordingly, the parking confirmation will be sent to the driver to confirm the modified reserved space. In addition, the guidance direction will be provided to guide the driver to drive to the modified reserved space from the current location of the vehicle of the driver. It is worth mentioning that when the modified reserved space is confirmed, the original reserved space will be automatically canceled. However, the original reserved space will not be canceled unless the modified reserved space is confirmed. Therefore, the driver can keep the original reserved space before the second reserve request is sent.

After the driver parks the vehicle at the reserved space, the driver is able to send a parked message to the confirmation center 30. Preferably, the driver is able to send the parked message from the management communicator 10 to the confirmation center 30 through the wireless communication network. Alternatively, the driver is able to use the confirmation code such as QR code as a parked message by scanning the confirmation code to a code reader preset in the parking structure. It is worth mentioning that the parking sensor will also detect the vehicle parked at the reserved space and record the vehicle license plate number, such that the system will confirm the corrected vehicle at the corrected parking space, especially when the parking request contains the vehicle license plate number.

When the driver returns back to the vehicle for leaving the parking structure, the driver is able to send the departure massage to the confirmation center 30. Once the departure message is received by the confirmation center 30, the payment center 40 will automatically calculate the parking fee and will automatically charge the parking fee from the driver. Accordingly, the driver is able to view the parking fee from the management communicator 10 through the electronic device. Once the vehicle is moved out from the reserved space, the parking data will be automatically updated in the database 21.

The method of the present invention further comprises a parking auction step for selling the reserved space, wherein the parking auction step comprises the following steps.

(A) Receive a parking auction request from the driver as a seller driver to the central computerized unit of the system, wherein the parking auction request contains information of the reserved space and auction price thereof. Before the seller driver returns back to the vehicle parked at the reserved space and leaves the parking structure, the seller driver is able to sell the reserved space to other drivers. The seller driver is able to submit the parking auction request to the communication module 22 to include the auction price. Preferably, the auction price should not be more than the parking fee paid by the seller driver. Once the parking auction request is posted to the communication module 22, other drivers, i.e. the buyer drivers, are able to view the reserved space on the map in the electronic devices of the buyer drivers to show the reserved space as the available parking space within the geographic parking location.

(B) Receive a parking auction response from other driver to the central computerized unit in response to the parking auction request. The parking auction response can be sent by the buyer drivers to the communication module 22 that buyer drivers are interested to select the reserved space from the seller driver. The buyer drivers are able to select the reserved space in the parking auction request by placing an auction offer in the parking auction response, such that the highest auction offer of the buyer driver will win the bid of the reserved space of the seller driver. Likewise, the buyer driver can directly “purchase” the reserved space of the seller driver in the parking auction request in response to the auction price. The “purchase” refers to the buyer driver taking over the reserved space of the seller driver, especially when no available parking space is provided within the geographic parking location. Therefore, the buyer driver has an option of biding the reserved space of the seller driver.

(C) Assign the reserved space from the seller driver to the buyer driver and completing a transaction between the drivers through the central computerized unit. Once the parking auction response from the buyer driver is confirmed by the seller driver, i.e. the seller driver admits to “sell” the reserved space, the confirmation center 30 will automatically assign the reserved space from the seller driver to the buyer driver. Therefore, the statue of the reserved space will not be changed back to “available” from “reserved” when the seller driver leaves the parking structure. As a result, other drivers will not able to select the reserved space. It is worth mentioning that the transaction between the seller driver and the buyer driver will be completed by the payment center 40. For registered users, the auction price will be automatically charged to the buyer driver and will be automatically deposit to the seller driver. Since the auction price should not be more than the parking fee paid by the seller driver, the auction price can be credited back to the seller driver from the parking fee thereof. It is worth mentioning that the buyer driver will pay for the auction price and the parking fee.

The following example illustrates the use of the system of the present invention. The driver is able to access the management communicator 10 through the electronic device in order to access the database 21 of the central management module 20. Through the wireless communication network, the driver is able to automatically send the parking request to the communication module 22 by inputting the destination or by the geographic location of the vehicle of the driver. The communication module 22 will feedback the corresponding parking data to the management communicator 10 of the driver, such that the parking data can be displayed on the map in the electronic device of the driver, via the mapping software thereof, within the geographic parking location to show any available parking space within the geographic parking location. Once the driver selects one of the available parking spaces, the driver is able to send the reserve request via the management communicator 10 to the confirmation center 30. The confirmation center 30 will automatically save the selected parking space as the reserved space for the driver. At the same time, the driver is guided to drive to the reserved space from the current location of the vehicle via the guidance direction. Once the driver parks the vehicle at the reserved space, the driver is able to send the parked message to the confirmation center 30, such that the system of the present invention will confirm the reserved space to be taken by the driver. If the reserved space is taken by other driver, the driver is able to contact the system of the present invention, such that a parking enforcement will be informed to help the driver to resolve the problem. It is worth mentioning that a signal will be generated to indicate the parking space being reversed and no one should park at the reversed parking space.

Before leaving, the driver, i.e. the seller driver, is able to place the parking auction request to the communication module 22. If other driver, i.e. the buyer driver, wants to take the reversed space from the driver, he or she can send the parking auction response to the communication module 22. Then, the seller driver is able to drive the vehicle and to leave the parking structure while the buyer driver can take the reversed space from the seller driver. If there is no parking auction response to the communication module 22, the seller driver is able to send the departure massage to the confirmation center 30 and the payment center 40 will automatically charge the parking fee from the driver.

According to the preferred embodiment, the system of the present invention can be configured for meter street parking space. In other words, the driver is able to search any available street parking space within the geographic parking location and is able to reverse the available street parking space. Preferably, the reversed sign of the street parking space will be shown at the corresponding meter thereof, such that no one should park on the reversed street parking space.

One skilled in the art will understand that the embodiment of the present invention as shown in the drawings and described above is exemplary only and not intended to be limiting.

It will thus be seen that the objects of the present invention have been fully and effectively accomplished. The embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A method of locating and managing parking space, comprising the steps of:
(a) collecting parking data regarding any available parking space within a geographic parking location by a central computerized unit in a real time manner, wherein a driver is able to wirelessly communicate with the central computerized unit through a wireless communication network;
(b) receiving a parking request from the driver, containing a geographic location of a vehicle of the driver, to the central computerized unit through the wireless communication network;
(c) sending out the parking data to the driver to be displayed on a map of the driver within the geographic parking location through the wireless communication network to show any available parking space within the geographic parking location;
(d) receiving a reserve request from the driver through the wireless communication network when any one of parking spaces is available; and
(e) indicating the available parking space selected by the driver as a reserved space.

2. The method, as recited in claim 1, further comprising a registering step of requesting the driver to register the central computerized unit as a registered user, such that when the registered user submits the reserve request to the central computerized unit, the reserved space is confirmed by personal infoiniation of the registered user.

3. The method as recited in claim 1 wherein, in the step (a), the parking data of one or more parking structures is collected regarding any available parking space of the parking structure within the geographic parking location by the central computerized unit in a real time manner.

4. The method as recited in claim 1 wherein, in the step (b), the parking request sent by the driver further contains mobile phone number of the driver, such that the reserved space is verified by the mobile phone number of the driver in a paperless ticket manner.

5. The method, as recited in claim 1, wherein the step (e) further comprises the steps of:
(e.1) sending out a parking confirmation of the reserved space to the driver; and
(e.2) frequently sending out a guidance direction to the driver to guide the driver to the reserved space on the map of the driver.

6. The method as recited in claim 1 wherein, in the step (d), the reserve request is sent by the driver when the vehicle of the driver is located within a predetermined distance range the available parking space.

7. The method, as recited in claim 1, wherein the step (c) further comprises the steps of:
(c.1) sending out parking regulations to the driver; and
(c.2) frequently updating the parking data to the driver to update the available parking space within the geographic parking location.

8. The method as recited in claim 1 wherein, in the step (e), when the available parking space is a fee-required parking space, applicable parking fee is charged after a predetermined time period at the time the reserved space is confirmed.

9. The method as recited in claim 8, wherein, in the step (e), the applicable parking fee is automatically charged by the central computerized unit when the vehicle of the driver leaves the reserved space.

10. The method as recited in claim 1, after the step (e), further comprising the steps of:
receiving a modifying request from the driver to the central computerized unit to request a location change of the reserved space;
sending out the parking data to the driver to be displayed on a map of the driver within the geographic parking location through the wireless communication network to show other available parking space within the geographic parking location;
receiving a second reserve request from the driver through the wireless communication network when any one of parking spaces is available; and
indicating the available parking space selected by the driver as a modified reserved space.

11. The method, as recited in claim 1, further comprising a parking auction step for selling the reserved space, wherein the parking auction step comprises the steps of:
receiving a parking auction request from the driver to the central computerized unit, wherein the parking auction request contains information of the reserved space and auction price thereof;
receiving a parking auction response from other driver to the central computerized unit in response to the parking auction request; and
assigning the reserved space from the driver to other driver and completing a transaction between the drivers through the central computerized unit.

12. The method as recited in claim 1 wherein, in the step (e), only one reserved space is selected at one time by the driver.

13. The method as recited in claim 1 wherein, in the step (e), the reserved space becomes open space when the reserved space is unoccupied by the driver after an expiring time limit.

14. A system of locating and managing parking space, comprising:
a management communicator adapted for being installed into and executed by a mobile electronic device of a driver;
a central management module which comprises:
a database, which collects parking data regarding any available parking space within a geographic parking location in a real time manner, adapted for being accessed by the mobile electronic device of the driver through a wireless communication network; and
a communication module operatively linked to the database, wherein the communication module receives a parking request from the management communicator, containing a geographic location of a vehicle of the driver, through the wireless communication network and sends out the parking data to the management communicator for being displayed on a map of the driver within the geographic parking location through the wireless communication network to show any available parking space within the geographic parking location; and
a confirmation center operatively linked to the communication module for receiving a reserve request from the management communicator through the wireless communication network when any one of parking spaces is available and for indicating the available parking space selected by the driver as a reserved space.

15. The system, as recited in claim 14, wherein the central management module further comprises a register center for the driver registering to the central management module as a registered user, such that when the reserve request is submitted to the confirmation center, the reserved space is confirmed by personal information of the registered user.

16. The system, as recited in claim 14, wherein the communication module is communicatively linked to the management communicator through a mobile communication network, such that the parking request sent by the management communicator further contains mobile phone number of the driver for verifying the reserved space by the mobile phone number of the driver in a paperless ticket manner

17. The system, as recited in claim 14, wherein the communication module further sends out a parking confirmation of the reserved space to the management communicator and frequently sends out a guidance direction to the management communicator for guiding the driver to the reserved space on the map of the driver.

18. The system, as recited in claim 14, wherein the reserve request is sent by the management communicator when the vehicle of the driver is located within a predetermined distance range the available parking space.

19. The system, as recited in claim 14, wherein the confirmation center comprises a transaction center operatively linked to the communication module for automatically charging applicable parking fee of the reserved space when the vehicle of the driver leaves the reserved space.

20. The system, as recited in claim 14, further comprising a parking auction center operatively linked to the confirmation center for allowing the driver selling the reserved space to other driver.
